(19) United States
(12) Patent Application Publication
(10) Pub. No.: US 2019/0347618 A1
(43) Pub. Date: Nov. 14, 2019

(54) AUTOMATED ANALYSIS OF DIGITAL PRODUCTION DATA FOR IMPROVED PRODUCTION EFFICIENCY

(71) Applicant: DISNEY ENTERPRISES, INC., Burbank, CA (US)

(72) Inventor: Scott A. ERICKSON, Glendale, CA (US)

(21) Appl. No.: 15/979,430

(22) Filed: May 14, 2018

(51) Int. Cl. G06Q 10/10; G06Q 10/06

(52) U.S. Cl. CPC G06Q 10/103; G06Q 10/101; G06Q 10/063118

(57) ABSTRACT

An automated production system generates and shares digital data associated with a cinematic feature. The automated production system includes a collection of different modules which correspond to different stages in a production pipeline. Each module generates and stores portions of the digital data and also generates and stores associations between portions of that data. Various modules then perform data analytics across multiple associated portions of digital data to determine sources of production inefficiency. Thus, the automated production system allows a production studio to more efficiently generate a feature by mitigating or eliminating specific technological inefficiencies that arise during production of the feature.

### BACKGROUND

### Field of the Various Embodiments

Various embodiments relate generally to cinematic productions and, more specifically, to automated analysis of digital production data for improved production efficiency.

### Description of the Related Art

Production studios oftentimes implement a production pipeline in order to generate and/or produce animated features. A given animated feature can vary by size or length and may be a full-length feature film, a short film, an episodic series, or a segment, among other types of features.

At the start of a typical production pipeline, a concept development team works with talent and creates a story (plot idea) for a feature. The concept development team creates characters and an environment to define the look and feel of the feature. If studio management greenlights the feature, studio management hires and assigns a producer who starts working with a writing team to extend the storyline by generating scripts. Scripts are then assigned to the feature. A line producer is hired and partnered with the producer to oversee the hiring of the rest of the production crew. The production crew includes artists, additional creative personnel, and supporting production management staff all of whom are involved with creating production assets for the feature. Each script is then broken down to determine what assets are needed to produce the feature. Assets typically include various forms of digital data: images, video clips, audio dialog, and sounds.

The production crew usually works with one or more supporting animation studios to generate animation content for the feature. The crew and/or animation studios may include in-house personnel as well as third-party contractors. The line producer also constructs a master project schedule according to which various tasks associated with producing the feature are to be performed. In conjunction with these steps, a team of artists generates concept art illustrating characters, props, backgrounds, and other visuals associated with the feature.

A production coordinator then generates one or more route sheets that include scene-by-scene instructions for generating the feature. The production coordinator transfers the scripts, master project schedule, concept art, and other materials to the animation studio. The animation studio works according to the schedule and the instructions included in the route sheets to generate a draft of the animated feature. When the draft is complete, the production studio management reviews the draft and typically requests one or more retakes for specific portions of the draft in need of modifications. The animation studio then revisits the draft of the feature and generates new content for those specific portions. This review and retake process repeats iteratively until the production studio management approves the draft. Once approved, a high-quality version of the animated feature is rendered and delivered for release.

Conventional production pipelines such as that described above involve numerous stakeholders storing and exchanging vast quantities of digital data. The digital data includes planning and coordination data, conceptual and/or artistic data, as well as media content included in the actual feature. Usually the various stakeholders rely on ad-hoc solutions for generating and sharing this data, including file sharing systems, email, and so forth. However, these approaches lead to certain inefficiencies.

In particular, different stakeholders oftentimes use different tools for generating and sharing the digital data. As a result, different portions of the digital data are usually dispersed across different physical or logical locations. This dispersion prevents meaningful data analytics from being performed in a holistic manner, thereby preventing production studio management from accurately judging the overall progress of production at any given point in time. For example, the line producer could generate the master project schedule using a cloud-based solution, while the animation studio could deliver portions of the draft feature using a file transfer application. The line producer might then have difficulty reconciling the delivered portions of the draft with the specific tasks set forth in the schedule because the schedule and the delivered portions of the draft are dispersed across different tools. Consequently, production studio management is prevented from effectively quantifying the degree to which production is on schedule and evaluating how well the different animation studios are operating.

In another example, production studio management could request retakes for a particular portion of the draft using a conventional communication tool, such as email. Those retakes could be associated with a specific scene of the feature that is set forth in a storyboard stored locally at the animation studio. The specific scene, in turn, could involve various art assets transferred to the animation studio using a file transfer system. Because the requested retakes, the related scene, and the relevant art assets are accessible via disparate tools, production studio management could have difficulty determining how many times, or to what extent, the animated feature has been modified in response to a given retake request. In practice, an animation studio could be requested to modify and re-deliver the same portion of the feature multiple times before the production studio management becomes aware of the iterations. Unknown or unchecked retakes and iterations can waste resources and cause surprise scheduling delays.

As the foregoing illustrates, conventional ad-hoc solutions to implementing a production pipeline for an animated feature do not allow meaningful data analytics to be performed during the production process. Without such analytics, production studios cannot efficiently coordinate and monitor the production of animated features. Accordingly, what is needed in the art are techniques for automatically analyzing production data to streamline the production process.

### SUMMARY

Various embodiments include a computer-implemented method for automatically determining inefficiencies when producing cinematic features, including generating, via a processor, a master project schedule associated with a cinematic feature, wherein the master project schedule includes a plurality of tasks associated with generating media assets to be included in the cinematic feature, generating, via the processor, a first task included in the plurality of tasks, where the first task indicates that a first crew member is assigned to generate a first media asset by or before a first deadline, analyzing, via the processor, the first task to determine a first value that indicates a number of times the first deadline has been modified, determining, via the processor, that the first value exceeds a first threshold, and generating, via the processor, a first report corresponding to the first crew member and indicating that at least one task assigned to the first crew member should be re-assigned to another crew member.

At least one advantage of the disclosed techniques is that the production studio can quantify the performance of a third-party animation studio based on hard data generated by the automated production system. Accordingly, the production studio can select between animation studios when producing features in a more informed manner, thereby limiting overhead and reducing inefficiencies. Because the automated production system solves a specific technological problem related to production pipeline inefficiencies, the approach described herein represents a significant technological advancement compared to prior art techniques.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual overview of a system configured to implement one or more aspects of the various embodiments;

FIG. 2 illustrates a computer-based implementation of the system of FIG. 1, according to various embodiments;

FIGS. 3A-3B set forth a more detailed illustration of datasets included in the implementation of FIG. 2, according to various embodiments.

FIG. 4A-4B set forth a more detailed illustration of datasets included in the implementation of FIG. 2, according to various other embodiments.

FIG. 5 is screenshot of an interface associated with a digital asset, according to various embodiments;

FIG. 6 is screenshot of an interface associated with a set of retakes, according to various embodiments; and

FIGS. 7A-7B set forth a flow diagram of method steps for automatically analyzing production data to determine one or more sources of inefficiency, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

As noted above, a production studio implements a production pipeline to produce animated features (and potentially other types of cinematic features). The production pipeline involves numerous stakeholders who exchange vast amounts of data. The different stakeholders oftentimes rely on many separate tools for storing and sharing data. Consequently, performing meaningful data analytics related to the production status of a given feature is difficult or impossible. Furthermore, specific inefficiencies arise due to this lack of meaningful analytics. For example, stakeholders may not be able to determine how closely an animation studio adheres to a master project schedule, because that schedule is disassociated from any media content generated by the animation studio. Similarly, stakeholders cannot determine whether a given animation studio requires excessive retakes because the retake requests, scene information, and art assets are dispersed across different tools.

To address these issues, various embodiments include an automated production system that generates and shares digital data associated with a cinematic feature. The automated production system includes a collection of different modules which correspond to different stages in a production pipeline. Each module generates and stores portions of the digital data and also generates and stores associations between portions of that data. Various modules then perform data analytics across multiple associated portions of digital data to determine sources of production inefficiency. In particular, a master project schedule module performs data analytics on schedule data in relation to shipping data generated by a shipping module to determine the degree to which the schedule is met. Additionally, a retakes module performs data analytics on retakes data in relation to production data and media assets to quantify the extent to which retakes are required. Thus, the automated production system allows a production studio to more efficiently generate a feature by mitigating or eliminating specific technological inefficiencies that arise during production of the feature.

At least one advantage of the disclosed techniques is that the production studio can quantify the performance of an animation studio based on hard data generated by the automated production system. Accordingly, the production studio can select between different animation studios in a more informed manner, thereby limiting overhead and reducing inefficiencies. Because the automated production system solves a specific technological problem related to production pipeline inefficiencies, the approach described herein represents a significant technological advancement compared to prior art techniques.

### Conceptual Overview

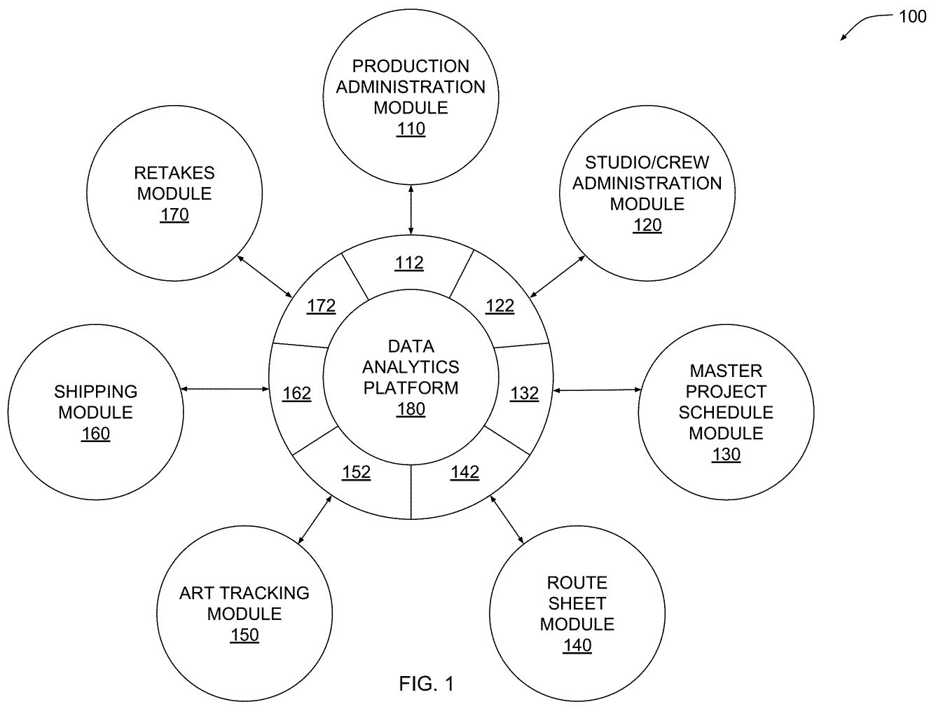

FIG. 1 is a conceptual overview of a system configured to implement one or more aspects of the various embodiments. As shown, an automated production system 100 includes a production administration module 110, a studio/crew administration module 120, a master project schedule module 130, a route sheet module 140, an art tracking module 150, a shipping module 160, and a retakes module 170. Each of the different modules included in automated production system 100 is coupled to a centralized data analytics platform 180 that is configured to store and analyze various datasets generated by those different modules. The datasets generally relate to the production of a cinematic feature.

As is shown, production administration module 110 generates production data 112 and stores that data on data analytics platform 180. Studio/crew administration module 120 generates studio/crew data 122 and stores that data on data analytics platform 180. Master project schedule module 130 generates master project schedule 132 and stores that schedule on data analytics platform 180. Route sheet module 140 generates route sheets 140 and stores those route sheets on data analytics platform 180. Art tracking module 150 generates art assets 152 and stores those assets on data analytics platform 180. Shipping module 160 generates shipping data 162 and stores that data on data analytics platform 180. Retakes module 170 generates retakes data 172 and stores that data on data analytics platform 180.

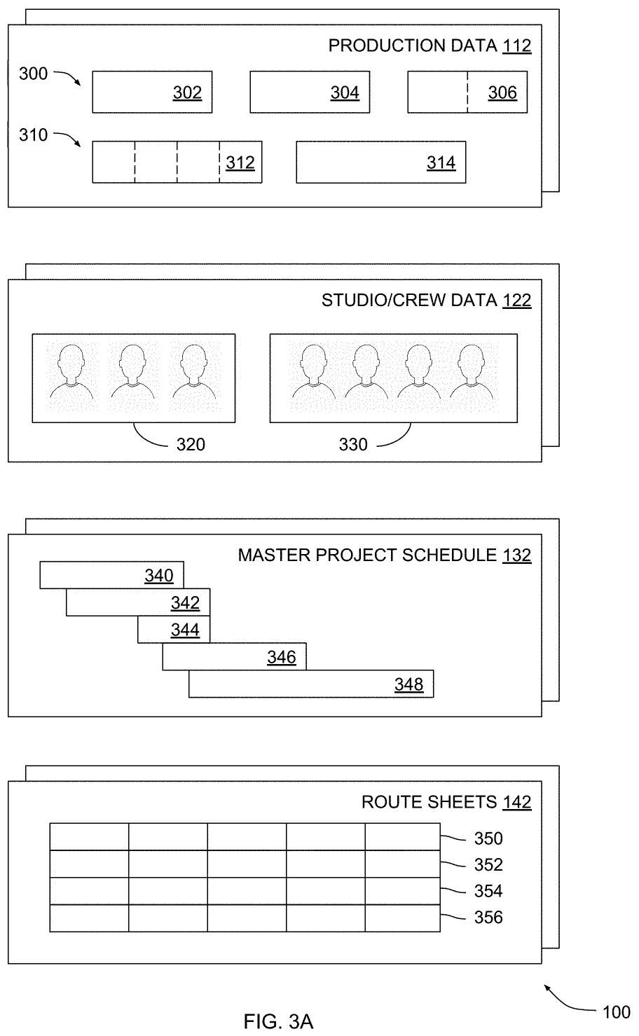

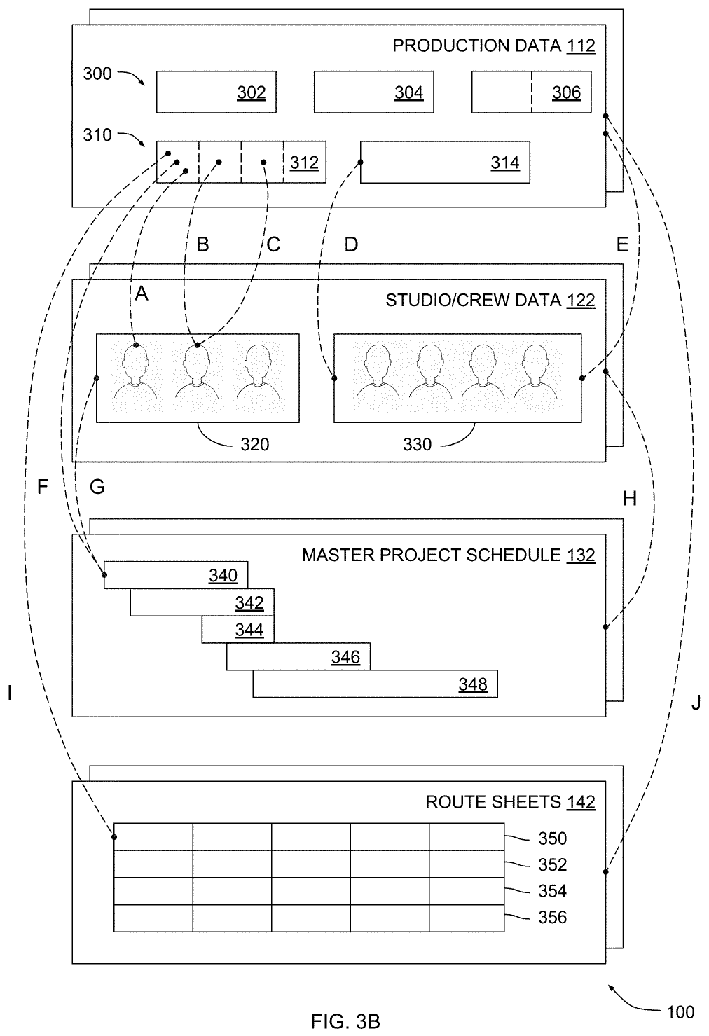

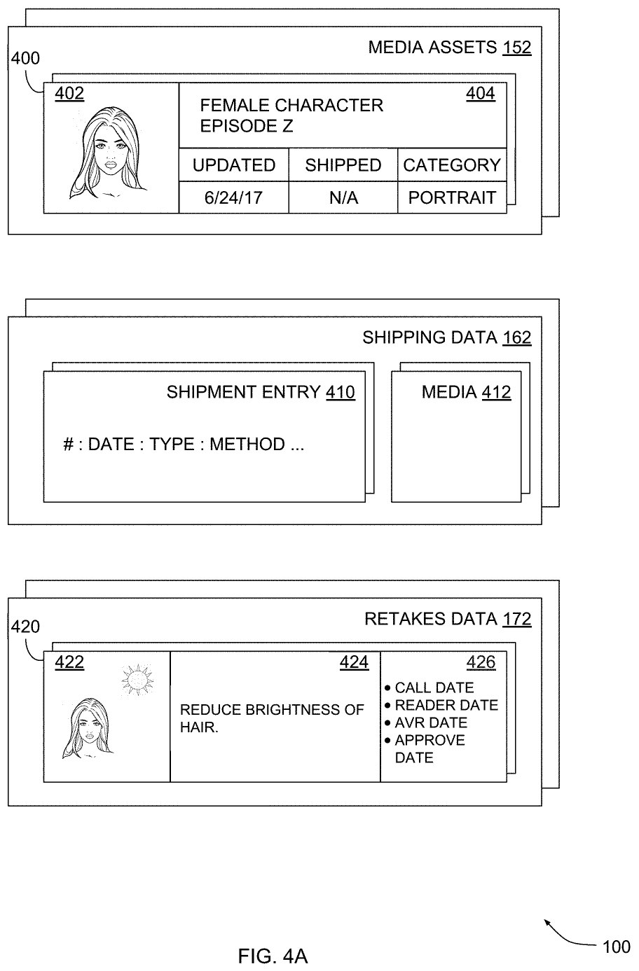

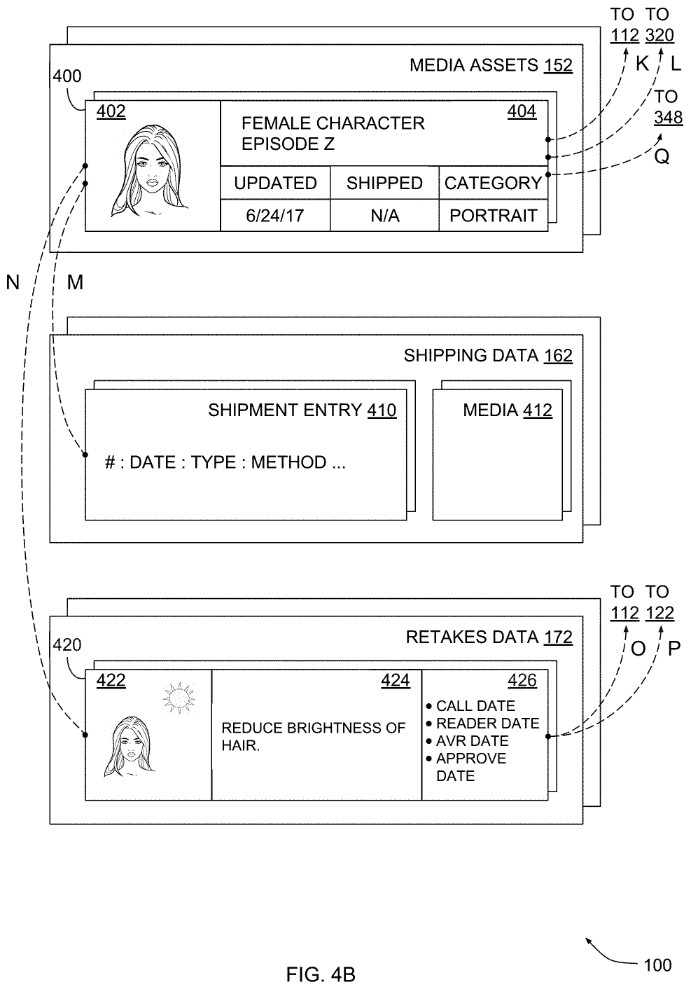

In addition to generating the datasets discussed above, any given module of automated production system 100 may also generate associations between different portions of data stored on data analytics platform 180. For example, studio/crew administration module 120 could generate associations between studio/crew data 122 and production data 112. A given association could indicate that a particular crew member is assigned a task associated with a specific portion of feature that is specified in production data 112. In another example, art tracking module 150 could generate associations between art assets 152 and production data 112, potentially indicating that a specific art asset is needed for a given scene of the feature, as specified in production data 112. The particular data that is generated and stored on data analytics platform 180, and the various associations between that data, are described in greater detail below in conjunction with FIGS. 3-4.

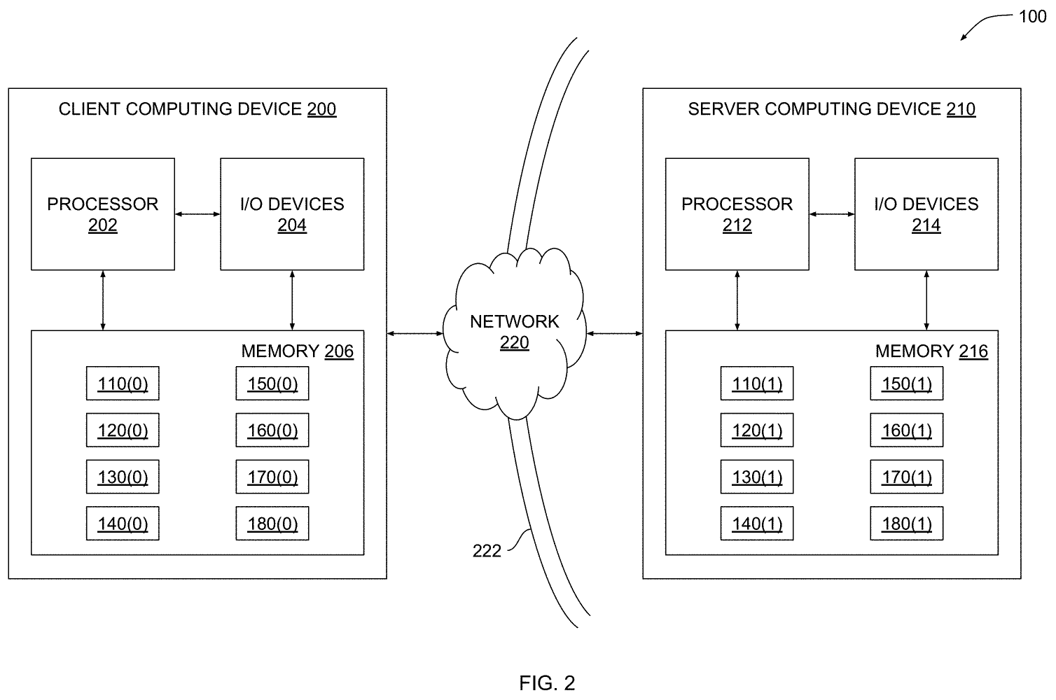

Because automated production system 100 generates numerous diverse datasets and also generates relevant associations between those datasets, automated production system 100 enables complex and meaningful data analytics to be performed. Those data analytics may provide significant insight into the overall progress of production of the feature. Based on hard data generated via these analytics, stakeholders in the feature can evaluate production to identify sources of inefficiency. Automated production system 100 may be implemented via many different technically feasible approaches. One such approach is discussed below in conjunction with FIG. 2.

### System Overview

FIG. 2 illustrates a computer-based implementation of the system of FIG. 1, according to various embodiments. As shown, automated production system 100 includes a client computing device 200 coupled to a server computing device 210 via a network 220. Network traffic across network 220 is governed by one or more firewalls 222.

Client computing device 200 includes a processor 202, input/output (I/O) devices 204, and a memory 206. Processor 202 may be any technically feasible hardware unit or collection thereof configured to process data and execute program instructions. I/O devices 204 include devices configured to provide output, receive input, and/or perform either or both such operations. Memory 206 may be any technically feasible computer-readable storage medium. Memory 206 includes software modules 110(0), 120(0), 130(0), 140(0), 150(0), 160(0), 170(0), and 180(0). Each such software module includes program instructions that, when executed by processor 202, perform specific operations described in greater detail below.

Similar to client computing device 200, client computing device 210 includes a processor 212, I/O devices 214, and a memory 216. Processor 212 may be any technically feasible hardware unit or collection thereof configured to process data and execute software instructions. I/O devices 214 include devices configured to provide output, receive input, and/or perform either or both such operations. Memory 216 may be any technically feasible computer-readable storage medium. Memory 216 includes software modules 110(1), 120(1), 130(1), 140(1), 150(1), 160(1), 170(1), and 180(1) that correspond to, and are configured to interoperate with, software modules 110(0), 120(0), 130(0), 140(0), 150(0), 160(0), 170(0), and 180(0), respectively.

Each corresponding pair of software modules is configured to interoperate to perform operations associated with a different module discussed above in conjunction with FIG. 1. In particular, software modules 110(0) and 110(1) interoperate to perform operations associated with production administration module 110, software modules 120(0) and 120(1) interoperate to perform operations associated with studio/crew administration module 120, software modules 130(0) and 130(1) interoperate to perform operations associated with master project schedule module 130, software modules 140(0) and 140(1) interoperate to perform operations associated with route sheet module 140, software modules 150(0) and 150(1) interoperate to perform operations associated with art tracking module 110, software modules 160(0) and 160(1) interoperate to perform operations associated with shipping module 160, software modules 170(0) and 170(1) interoperate to perform operations associated with retakes module 170, and software modules 180(0) and 180(1) interoperate to perform operations associated with data analytics platform 180. In one embodiment, some or all of the software modules discussed thus far may be consolidated into a single software entity.

In the exemplary implementation described herein, automated production system 100 is a distributed cloud-based entity that includes client-side code executing on one or more client computing devices 200 and server-side code executing on one or more server computing devices 210. The different computing devices shown may be physical computing devices or virtualized instances of computing devices. Persons skilled in the art will understand that various other implementations may perform any and all operations associated with automated production system 100, beyond that which is shown here. The datasets generated by each module of automated production system 100, and the different interrelationships between those datasets, are described in greater detail below in conjunction with FIGS. 3-4.

### Analysis of Digital Production Data

FIGS. 3A-3B set forth a more detailed illustration of datasets included in the implementation of FIG. 2, according to various embodiments. The particular datasets described in conjunction with FIGS. 3A-3B include production data 112, studio/crew data 122, master project schedule 132, and route sheets 142, as is shown.

Referring to FIG. 3A, production data 112 includes episode data 300 and 310. Episode data 300 and 310 represent one example of data that is generated by production administration module 110 in conjunction with the generation and production of a feature. In this example, the feature is an episodic series, and episode data 300 and 310 correspond to different episodes in that series. Episode data 300 includes segments 302, 304, and 306, each of which may be further subdivided into one or more scenes. Similarly, episode data 310 includes segments 312 and 314 that also may be further subdivided into one or more scenes. Production administration module 110 generates production data 112 to define the structure and scene organization of the feature being produced. Production administration module 110 may also generate additional data to be included in production data 112, such as specific user accounts, security groups, and other configuration options. As also described in greater detail below in conjunction with FIG. 4B, production administration module 110 generates associations between elements of production data 112 and other related data in order to facilitate data analytics.

Studio/crew data 122 includes crew profiles 320 and 330. Each crew profile indicates data associated with one or more crew members. A given crew profile may represent crew members associated with the production studio and/or crew members associated with a third-party contractor, such as an external animation studio. Studio/crew module 120 generates studio/crew data 122 to track details associated with crew members crews, and studios, and also generates associations between these elements and other data in order to facilitate data analytics. Exemplary associations are discussed in greater detail below in conjunction with FIG. 3B.

Master project schedule 132 includes a collection of tasks organized according to start date and end date. In one embodiment, master project schedule 132 may be rendered as a Gantt chart. Master project schedule 132 includes tasks 340, 342, 344, 346, and 348. Each task sets forth a particular objective associated with generation of the feature. For example, a given task included in master project schedule 132 could relate to generating the art assets needed for segment 312. Master project schedule module 132 may generate associations between tasks and other data, examples of which are shown in FIG. 3B.

Route sheets 142 include instructions 350, 352, 354, and 356. Each instruction includes highly granular directives for generating specific portions of the feature. For example, a given instruction included in route sheets 142 could describe the formatting of the title screen associated with the feature. Route sheet module 140 also generates associations between route sheets and tasks, crew members, and other data. FIG. 3B illustrates exemplary associations generated in this manner.

As a general matter, any given module of automated production system 100 may generate associations between any of the data discussed thus far. Automated production system 100 generates these associations in order to facilitate data analytics, as mentioned. FIG. 3B illustrates several exemplary associations.

Referring now to FIG. 3B, associations A-J represent different types of relationships that can exist between different datasets and/or different data elements. Association A represents a relationship between a crew member specified in crew profile 320 and a scene within segment 312 set forth in episode data 310. Association A could indicate, for example, that the crew member is responsible for finalizing that particular scene. Associations B and C indicate a similar relationship between another crew member and two other scenes of segment 312. Association D indicates a relationship between crew profile 330 and segment 314, while association E indicates a relationship between crew 330 and production data 112 as a whole. Any of the aforesaid associations A-E may represent an assignment between a crew or crew member and a portion of the feature. Any given association may also confer specific security privileges to the crew or crew member in relation to that portion of the feature. Studio/crew module 120 may generate these associations in order to assign different studios and/or different crews to different portions of the feature.

Associations F-H indicate relationships between particular tasks set forth in master project schedule 132, a responsible crew or crew member, and a given portion of the feature. For example, association F relates task 340 to a scene of segment 312 while association G relates task 340 to crew profile 320. Here, task 340 is associated with production of a scene of segment 312 and is assigned to the crew specified in crew profile 320. Association H indicates that all crew members set forth in studio/crew data 122 have access to master project schedule 132. Master project schedule module 130 generates associations F-H to assign tasks associated with production of the feature to particular crews or crew members.

Associations I and J relate some or all of route sheets 142 to production data 112. For example, association I indicates that a given scene of segment 312 should be generated according to instruction 350. Association J relates route sheets 142 as a whole to production data 112. Route sheets module 140 generates associations I and J to enable the efficient analysis of whether portions of the feature adhere to the associated instructions.

Referring generally to FIGS. 3A-3B, the particular datasets discussed above, and the various associations between those datasets and portions therein, enable complex data analytics to be performed by modules within automated production system 100. For example, master project schedule module 130 could analyze a task included in master project schedule 132 and then determine, based on an association between the task and a portion of production data 112, whether the task is complete. Then, master project schedule module 130 could identify the crew or crew members associated with any incomplete tasks and then notify those individuals that the incomplete tasks should be addressed.

In one embodiment, master project schedule module 130 is configured to periodically analyze each task and record when a deadline associated with any given task is moved or modified. Master project schedule module 130 also records the particular crew member responsible for modifying any given deadline. Master project schedule module 130 logs the number of times each deadline is modified and then generates a report when that number exceeds a threshold. The report indicates that the crew member assigned to the task may be at risk for falling behind schedule and may also indicate specific tasks that should be re-assigned from the crew member to other crew members. The threshold may be configurable and may be determined on a per-crew member basis based on historical data. For example, master project schedule module 130 could set a lower threshold for a crew member who historically misses many deadlines, and set a higher threshold for a crew member who historically misses few deadlines. In this manner, master project schedule module 130 automatically performs analytics on production data to facilitate the expedient completion of tasks and delivery of art assets. This approach may increase production efficiency by lowering the overhead traditionally involved with keeping tasks on schedule. FIGS. 4A-4B illustrate additional data and associations related to other modules of automated production system 100.

FIGS. 4A-4B set forth a more detailed illustration of datasets included in the implementation of FIG. 2, according to various other embodiments. The particular datasets described in conjunction with FIGS. 4A-4B include media assets 152, shipping data 162, and retakes data 172, as is shown.

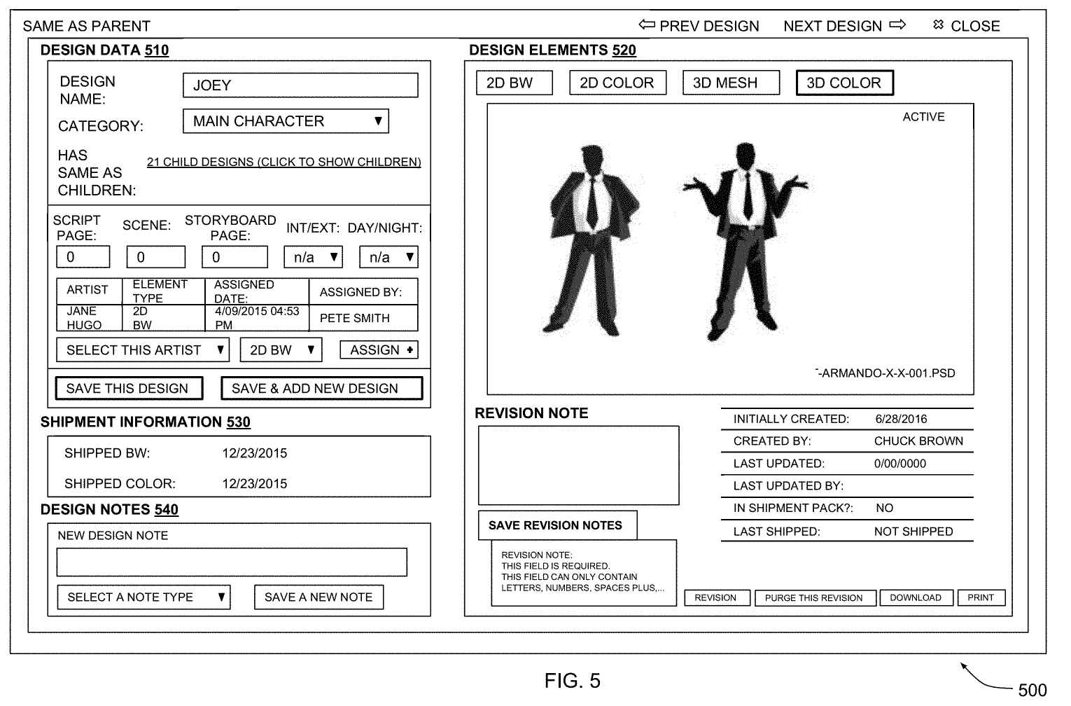

Referring now to FIG. 4A, media assets 152 include multiple media entries 400, each corresponding to a different artistic element that may be included in the feature. A given media entry 400 could describe, for example, a character, a prop, an item, a background, and any other type of graphical element. The exemplary entry shown includes a thumbnail 402 and a name 404, along with other metadata. Additional metadata that may be associated with media entries is described in greater detail below in conjunction with FIG. 5. Art tracking module 150 is configured to generate each entry within media assets 152 in order track those entries and also associate each entry to specific portions of the feature, particular crew members, and various other data stored and processed within data analytics platform 180. FIG. 4B illustrates exemplary associations between media assets 152 and other data.

Shipping data 162 specifies various shipment entries 410. A shipment entry 410 describes a shipment of media that may occur between the production studio and other parties, including third-party animation studios, among others. A given shipment entry 410 describes the status of the shipment, the type of shipment, how the shipment is delivered, and so forth. Shipments generally relate to art assets associated with specific portions of the feature, as well as drafts and final renderings of the feature itself. Media 412 may include the actual shipped content or may refer to another location where the content is stored. A shipment may be delivered electronically or physically. In either case, shipping module 160 generates shipment entry 410 to track the status of the shipped media. Shipping module 160 may also generate associations between shipment entries 410 and tasks set forth in master project schedule 132, among other associations discussed in greater detail below in conjunction with FIG. 4B.

Retakes data 172 includes retakes entries 420. Each retakes entry relates to a specific portion of the feature and/or a draft of the feature and reflects changes that should be made to that portion. A given retakes entry 420 includes a thumbnail image 422, feedback 424, and various metadata 426. Thumbnail image 422 represents the portion of the feature needing changes, feedback 424 describes the specific changes to be made, and metadata 426 indicates various dates and other descriptive information related to the portion of the feature and/or the retake entry 420. Retakes module 170 generates retakes data 172 in order to communicate to a given crew member or crew that the specified portion of the feature (or draft thereof) needs the indicated changes. In doing so, retakes module 170 generates particular associations between retakes entry 420 and various other data, including media assets 152, studio/crew data 122, and so forth.

Referring now to FIG. 4B, associations K-Q represent different types of relationships that can exist between particular datasets and/or data elements. Association K relates media entry 400 back to a portion of production data 112. Association K could, for example, relate media entry 400 to a particular scene set forth in episode data 310 where the character indicated in media entry 400 appears. Association L ties media entry 400 to a particular crew member 320, crew, or studio defined in studio/crew data 122.

Associations M and N relate media entry 400 to shipment entry 410 and retake entry 420, respectively. Association M could indicate, for example, that the media content described by media entry 400 was shipped according to the dataset forth in shipment entry 410. Association N could indicate, for example, that a portion of the feature where the character corresponding to media entry 400 appears needs to be modified. In the example show, feedback 424 indicates that the brightness of the character's hair needs to be adjusted. Association O relates retakes entry 420 back to production data 112, potentially indicating the portion of the feature that needs to be modified. Association P relates retakes entry 420 back to studio/crew data 122, possibly indicating that a particular crew member, crew, or studio is responsible for performing the needed modifications. Association Q relates media entry 400 to a specific task 348 within master project schedule 132, potentially indicating that the associated media content should be completed by a deadline associated with task 348.

Referring generally to FIGS. 3A-4B, the various data and associations set forth in conjunction with these figures is exemplary and meant only to illustrate the types of data and associations that can be generated and analyzed by modules within automated production system 100. In one embodiment, automated production system 100 generates various data and associations based on feedback received from users of automated production system 100. Upon generating such data and associations, automated production system 100 may then perform the above-described data analytics in order to identify inefficiencies associated with production of the feature, as mentioned.

In particular, automated production system 100 may analyze master project schedule 132 to identify particular tasks that are behind schedule based on associations between those tasks and shipping data 162 that is generated when those tasks are complete. Automated production system 100 may generate detailed reports quantifying the progress of each task in relation to various deliverables indicated in associated shipping data 162. Master project schedule module 130, specifically, may perform the above operations.

Automated production system 100 may also analyze retakes data 172 to identify particular portions of the feature for which excessive retakes have been requested. Automated production system 100 may also identify, based on associations between retakes dated 172 and studio/crew data 122, one or more entities responsible for the excessive retakes. Automated production system 100 may generate detailed reports quantifying the extent to which such retakes are needed. Retakes module 170, in particular, may perform these operations. In this manner, automated production system 100 analyzes the data and associations discussed herein to identify sources of inefficiency. Automated production system 100 is configured to quantify these inefficiencies in order to provide metrics according to which the production studio management can execute more informed decisions when selecting between third party contractors.

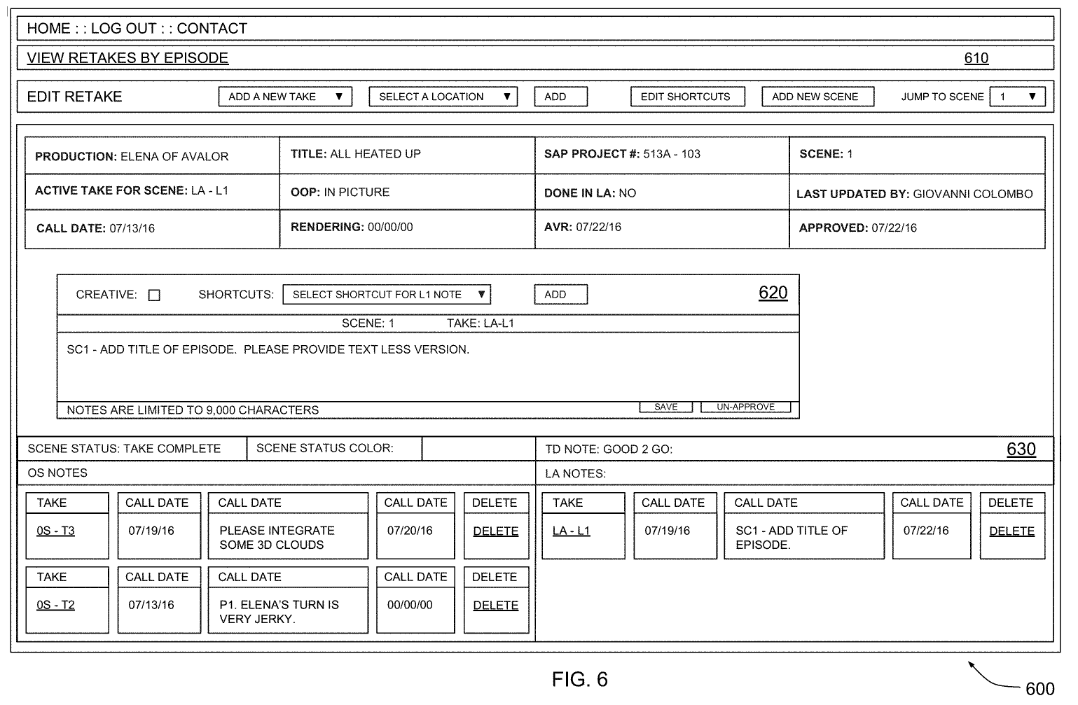

As described thus far, various modules within automated production system 100 generate detailed data and metadata related to the production of a cinematic feature. In addition, automated production system 100 generates associations between that data and metadata according to which data analytics can be performed. FIGS. 5-6 set forth exemplary screenshots of interfaces via which such data, metadata, and associations can be generated.

### Exemplary Interfaces for Generating Production Data

FIG. 5 is screenshot of an interface associated with a digital asset, according to various embodiments. As shown, interface 500 includes a design data panel 510, a design elements panel 520, shipment information panel 530, and design notes panel 540. Design data panel 510 includes a set of fields that define metadata associated with a media asset. That metadata includes a design name, a category, an artist name, a design type, and so forth. Design data panel 510 also includes fields defining associations between the media asset and other data. For example, design data panel 510 indicates the particular script page, scene, and storyboard page where the media asset appears. These associations may correspond to associations between an entry in media assets 152 and portions of production data 112, similar to those shown in FIG. 3B.

Design elements panel 520 describes the physical appearance of the media asset, including graphics depicting the media asset and other metadata associated with the media asset, such as the date created, date updated, and so forth. Design elements panel 520 may reflect data included in a media entry 400, such as that shown in FIGS. 4A-4B. Shipment information panel 530 indicates various dates when versions of the media asset shipped. Shipment information panel 530 may be populated by accessing a shipment entry 410 corresponding to the media asset.

Art tracking module 150 generates interface 500 to capture and/or or update data related to the potentially numerous media assets included in the feature. Art tracking module 150 and/or other modules within automated production system 100 are configured to analyze this data to identify scheduling delays, as described, and potentially other inefficiencies. For example, art tracking module 150 could analyze the number of media assets assigned to each artist and then determine that a particular artist is assigned to work on too many assets, potentially leading to production delays. Art tracking module 150 may then generate a report suggesting that those assignments be re-assigned to balance workload across other artists.

In one embodiment, art tracking module 150 interacts with a media generation module (not shown) to automatically generate media content depicting credits to be included at the beginning or end of the feature. In particular, art tracking module 150 analyzes the feature to determine the specific art assets used in the feature and the screen exposure time associated with each asset. Art tracking module 150 may also interoperate with master project schedule module 130 to identify particular art-related tasks that are marked as complete. Then, art tracking module 150 generates a data structure that describes a set of artists (or other crew members) who contributed to the feature, the particular tasks completed by those artists, an amount of screen exposure associated with the assets generated by those artists, and potentially other meta data reflecting the degree and scope of contribution by each artist, including different titles and/or roles associated with those artists. Art tracking module 150 then generates a credit sequence based on this data structure and based on a template for generating credit sequences. The template may define the organization and appearance of the credits. Art tracking module 150 may also rank artists based on the proportion of the cinematic feature associated with those artists, and then organize the credit sequence according to the ranking, thereby allowing higher performing artists to appear before lower performing artists in the credit sequence. The credit sequence can then be incorporated into the feature to credit each artist with various contributions to production of the feature. One advantage of this approach is that the production studio need not manually create credit sequences, thereby conserving production resources.

FIG. 6 is screenshot of an interface associated with a set of retakes, according to various embodiments. As shown, interface 600 includes a retakes panel 610, a feedback panel 620, and a scene panel 630. Retakes panel 610 includes a set of fields populated with the various metadata related to a given retake. The metadata may include relevant identification numbers, dates, timing information, and so forth, and may also define associations to other data, including production data 112 and studio/crew data 122, among others. Feedback panel 620 includes feedback associated with a particular portion of a draft of the feature. This feedback typically indicates modifications that need to be made to the portion of the future. Feedback may be generated by production studio management and may be directed towards third-party contractors, such as third-party animation studios. Feedback panel 620 may indicate associations between feedback and one or more crew members responsible for addressing that feedback by performing the requested modifications. Scene panel 630 includes metadata related to a scene that includes the portion of the feature for which the retake is requested.

Retakes module 170 generates interface 600 in order to capture input based on which retakes data 172 can be generated. Retakes module 170 also generates associations between retakes data 172 and other data, such as the associations shown in FIG. 4B. Retakes module 170 performs data analytics with retakes data 172 in order to identify sources of inefficiency associated with performing retakes, as previously mentioned. For example, retakes module 170 could analyze retakes data and then determine that a disproportionate number of retakes are assigned to a particular crew member. Then, retakes module 170 could generate a report suggesting that the assignment of retakes should be rebalanced. Alternatively, retakes module 170 could analyze retakes data 172 and then determine that a particular animation studio produces media content requiring an excessive number of retakes compared to other animation studios. Then, retakes module 170 could generate a report that includes a metric which rates the performance of the animation studio compared to other animation studios. The metric could indicate, for example, the percentage of media content delivered by the animation studio that must be modified.

Referring generally to FIGS. 1-6, any of the modules within automated production system 100 may generate and analyze the data, metadata, and associations discussed thus far in order to identify production inefficiencies. In doing so, any such module may interoperate with data analytics platform 180 to offload processing and/or storage tasks. The various modules may also generate detailed reports describing production inefficiencies and potentially suggesting changes that can be made in order to mitigate the inefficiencies. Automated production system 100 thereby represents a technical solution to a technical problem related to how production data is processed and analyzed.

### Procedure for Determining Sources of Inefficiency

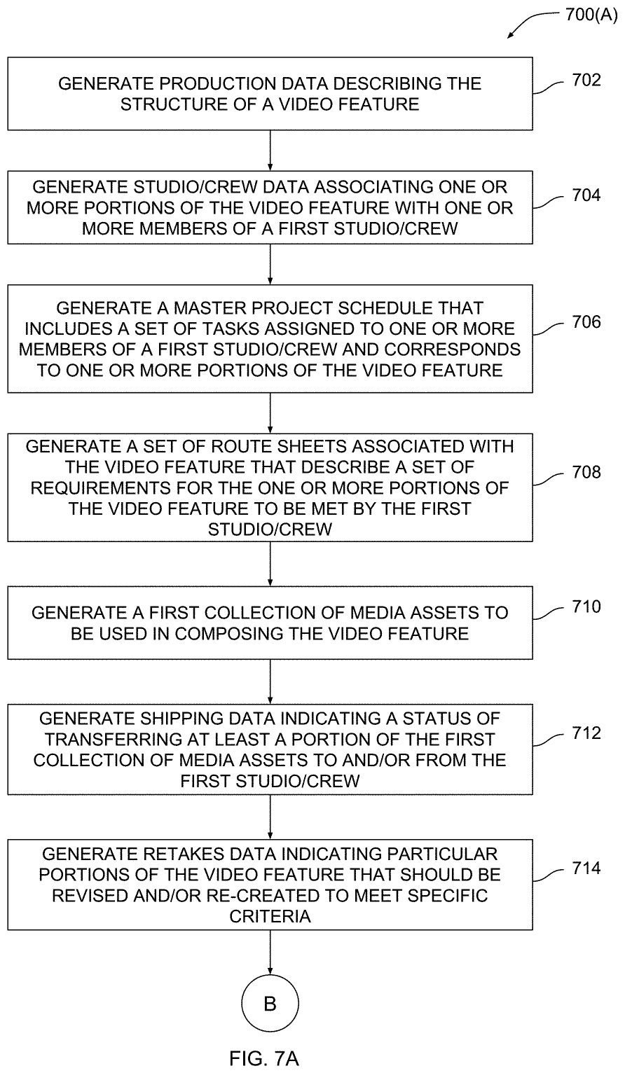

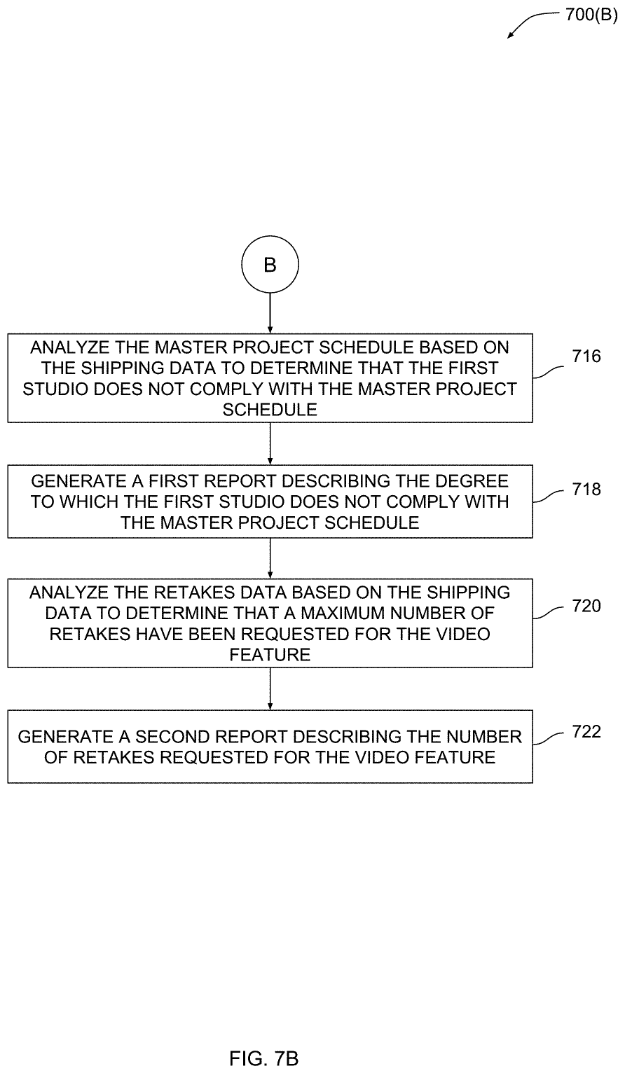

FIGS. 7A-7B set forth a flow diagram of method steps for automatically analyzing production data to determine one or more sources of inefficiency, according to various embodiments. Although the method steps are described in conjunction with the systems of FIGS. 1-6, persons skilled in the art will understand that any system may be configured to perform the method steps in any order.

As shown in FIG. 7A, a method 700 begins at step 702, where production administration module 110 generates production data 112 describing the structure of a cinematic feature, such as a feature-length film, episode in a series, and so forth. At step 704, studio/crew administration module 120 generates studio/crew data 122 associating one or more portions of the feature with one or more members of a first studio/crew. Such associations may indicate that the first studio/crew is assigned to work on the one or more portions of the feature. At step 706, master project schedule module 130 generates a master project schedule 132 that includes a set of tasks assigned to the first studio/crew and corresponding one or more portions of the cinematic feature. At step 708, route sheet module 140 generates a set of route sheets 142 associated with the cinematic feature that describe a set of requirements for the one or more portions of the video feature to be met by the first studio/crew.

At step 710, art tracking module 150 generates a first collection of media assets to be used in composing the cinematic feature. Art tracking module 150 they associate the first collection of media assets with the first studio/crew to provide to the first studio/crew with access to at least a portion of the first collection of media assets. At step 712, shipping module 160 generates shipping data 162 indicating a status of transferring at least a portion of the first collection of media assets to and/or from the first studio/crew. At step 714, retakes module 170 generates retakes data indicating particular portions of the video feature that should be revised and/or re-created to meet specific criteria. Production studio management may provide feedback that is incorporated into retakes data 170 and provided to the first studio/crew in order to provide guidance to the first studio/crew in revising and/or re-creating the indicated portions of the feature. In the above portion of the method 700, various modules within automated production system 100 generate various data and associations which can then be processed by data analytics platform 180, as described in greater detail below in conjunction with FIG. 7B.

Referring now to FIG. 7B, at step 716, master project schedule module 130 analyzes master project schedule 132 based on shipping data 162 to determine that the first studio/crew does not comply with master project schedule 132. Such non-compliance could specifically indicate that the first studio/crew has not completed specific assigned tasks and/or has not shipped content to the production studio in a timely manner, among other issues. At step 718, master project schedule module 130 generates a first report describing the degree to which the first studio does not comply with the master project schedule. The first report could indicate, for example, the number of tasks that are past due according to master project schedule 132. At step 720, retakes module 170 analyzes retakes data 172 based on shipping data 162 to determine that a maximum number of retakes have been requested for a portion of the cinematic feature. At step 722, retakes module 170 generates a second report describing the number of retakes requested for the video feature.

By implementing the method 700, automated production system 100 generates and then analyzes data and associations that reflect the overall progress of the production of a cinematic feature. Based on these analyses, automated production system 100 determines sources of inefficiency associated with the production of the feature and may then initiate various actions to mitigate those inefficiencies.

In sum, an automated production system generates and shares digital data associated with a cinematic feature. The automated production system includes a collection of different modules which correspond to different stages in a production pipeline. Each module generates and stores portions of the digital data and also generates and stores associations between portions of that data. Various modules then perform data analytics across multiple associated portions of digital data to determine sources of production inefficiency. Thus, the automated production system allows a production studio to more efficiently generate a feature by mitigating or eliminating specific inefficiencies that arise during production of the feature.

At least one advantage of the disclosed techniques is that the production studio can quantify the performance of a third-party animation studio based on hard data generated by the automated production system. Accordingly, the production studio can select between animation studios when producing features in a more informed manner, thereby limiting overhead and reducing inefficiencies. Because the automated production system solves a specific technological problem related to production pipeline inefficiencies, the approach described herein represents a significant technological advancement compared to prior art techniques.

Any and all combinations of any of the claim elements recited in any of the claims and/or any elements described in this application, in any fashion, fall within the contemplated scope of the present embodiments and protection.

1. Some embodiments include a computer-implemented method for automatically determining inefficiencies when producing cinematic features, the method comprising: generating, via a processor, a master project schedule associated with a cinematic feature, wherein the master project schedule includes a plurality of tasks associated with generating media assets to be included in the cinematic feature; generating, via the processor, a first task included in the plurality of tasks, wherein the first task indicates that a first crew member is assigned to generate a first media asset by or before a first deadline; analyzing, via the processor, the first task to determine a first value that indicates a number of times the first deadline has been modified; determining, via the processor, that the first value exceeds a first threshold; and generating, via the processor, a first report corresponding to the first crew member and indicating that at least one task assigned to the first crew member should be re-assigned to another crew member.

2. The computer-implemented method of clause 1, further comprising: analyzing, via the processor, the plurality of tasks to determine a second value that indicates a total number of times any deadline associated with any task assigned to the first crew member has been modified; and generating, via the processor, a second report that indicates the second value.

3. The computer-implemented method of any of clauses 1 and 2, further comprising: determining, via the processor, a third value that indicates a total number of times any previous deadline associated with any previous task assigned to the first crew member has been modified; and computing, via the processor, the first threshold based on the third value.

4. The computer-implemented method of any of clauses 1, 2, and 3, further comprising: determining, via the processor, that the first task is complete; and updating, via the processor, a first media asset entry corresponding to the first media asset to indicate that the first media asset can be included in the cinematic feature.

5. The computer-implemented method of any of clauses 1, 2, 3, and 4, further comprising: analyzing, via the processor, the master project schedule to determine that the first crew member has completed the first task; determining, via the processor, a first amount of screen time associated with the first media asset; and generating, via the processor, at least a portion of the cinematic feature based on the first amount of screen time.

6. The computer-implemented method of any of clauses 1, 2, 3, 4, and 5, further comprising: analyzing, via the processor, the master project schedule to determine a first subset of tasks included in the plurality of tasks that have been completed by the first crew member; analyzing, via the processor, the first subset of tasks to identify a first subset of media assets corresponding to the first subset of tasks; computing, via the processor, a first amount of screen time associated with the first subset of tasks, wherein the first amount of screen time indicates a proportion of the cinematic feature that includes any media asset generated by the first crew member; and generating a credits sequence based on the first amount of screen time

7. The computer-implemented method of any of clauses 1, 2, 3, 4, 5, and 6, wherein the credits sequence indicates a type of contribution made by the first crew member to production of the cinematic feature.

8. The computer-implemented method of any of clauses 1, 2, 3, 4, 5, 6, and 7, further comprising assigning a first rank to the first crew member relative to other crew members based on the first amount of screen time, wherein the first crew member is specified within the credit sequence at a position according to the first rank.

9. The computer-implemented method of any of clauses 1, 2, 3, 4, 5, 6, 7, and 8, further comprising generating a first portion of the cinematic feature based on a number of tasks included in the plurality of tasks completed by the first crew member.

10. The computer-implemented method of any of clauses 1, 2, 3, 4, 5, 6, 7, 8, and 9, wherein the first portion of the cinematic feature indicates that the first crew member assisted in creating the cinematic feature.

11. Some embodiments include a non-transitory computer-readable medium storing program instructions that, when executed by a processor, cause the processor to automatically determine inefficiencies when producing cinematic features by performing the steps of: generating, via a processor, a master project schedule associated with a cinematic feature, wherein the master project schedule includes a plurality of tasks associated with generating media assets to be included in the cinematic feature; generating, via the processor, a first task included in the plurality of tasks, wherein the first task indicates that a first crew member is assigned to generate a first media asset by or before a first deadline; analyzing, via the processor, the first task to determine a first value that indicates a number of times the first deadline has been modified; determining, via the processor, that the first value exceeds a first threshold; and generating, via the processor, a first report corresponding to the first crew member and indicating that at least one task assigned to the first crew member should be re-assigned to another crew member.

12. The non-transitory computer-readable medium of clause 11, further comprising the steps of: analyzing, via the processor, the plurality of tasks to determine a second value that indicates a total number of times any deadline associated with any task assigned to the first crew member has been modified; and generating, via the processor, a second report that indicates the second value.

13. The non-transitory computer-readable medium of any of clauses 11 and 12, further comprising the steps of: determining, via the processor, a third value that indicates a total number of times any previous deadline associated with any previous task assigned to the first crew member has been modified; and computing, via the processor, the first threshold based on the third value.

14. The non-transitory computer-readable medium of any of clauses 11, 12, and 13, further comprising the steps of: determining, via the processor, that the first task is complete; and updating, via the processor, a first media asset entry corresponding to the first media asset to indicate that the first media asset can be included in the cinematic feature.

15. The non-transitory computer-readable medium of any of clauses 11, 12, 13, and 14, further comprising: analyzing, via the processor, the master project schedule to determine that the first crew member has completed the first task; determining, via the processor, a first amount of screen time associated with the first media asset; and generating, via the processor, at least a portion of the cinematic feature based on the first amount of screen time.

16. The non-transitory computer-readable medium of any of clauses 11, 12, 13, 14, and 15, further comprising the steps of: analyzing, via the processor, the master project schedule to determine a first subset of tasks included in the plurality of tasks that have been completed by the first crew member; analyzing, via the processor, the first subset of tasks to identify a first subset of media assets corresponding to the first subset of tasks; computing, via the processor, a first amount of screen time associated with the first subset of tasks, wherein the first amount of screen time indicates a proportion of the cinematic feature that includes any media asset generated by the first crew member; and generating a credits sequence based on the first amount of screen time

17. The non-transitory computer-readable medium of any of clauses 11, 12, 13, 14, 15, and 16, wherein the credits sequence indicates a scope of contribution made by the first crew member to creation of the cinematic feature.

18. The non-transitory computer-readable medium of any of clauses 11, 12, 13, 14, 15, 16, and 17, further comprising generating an indication of the first crew member within the credit sequence at a position that is derived from the first amount of screen time.

19. The non-transitory computer-readable medium of any of clauses 11, 12, 13, 14, 15, 16, 17, and 18, further comprising the step of generating a first portion of the cinematic feature based on a number of tasks included in the plurality of tasks completed by the first crew member, wherein the first portion of the cinematic feature indicates that the first crew member assisted in creating the cinematic feature.

20. Some embodiments include a system, comprising: a memory storing an analytics application; and a processor that, when executing the analytics application, is configured to perform the steps of: generating, via a processor, a master project schedule associated with a cinematic feature, wherein the master project schedule includes a plurality of tasks associated with generating media assets to be included in the cinematic feature, generating, via the processor, a first task included in the plurality of tasks, wherein the first task indicates that a first crew member is assigned to generate a first media asset by or before a first deadline, analyzing, via the processor, the first task to determine a first value that indicates a number of times the first deadline has been modified, determining, via the processor, that the first value exceeds a first threshold, and generating, via the processor, a first report corresponding to the first crew member and indicating that at least one task assigned to the first crew member should be re-assigned to another crew member.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for automatically determining inefficiencies when producing cinematic features, the method comprising:
generating, via a processor, a master project schedule associated with a cinematic feature, wherein the master project schedule includes a plurality of tasks associated with generating media assets to be included in the cinematic feature;
generating, via the processor, a first task included in the plurality of tasks, wherein the first task indicates that a first crew member is assigned to generate a first media asset by or before a first deadline;
analyzing, via the processor, the first task to determine a first value that indicates a number of times the first deadline has been modified;
determining, via the processor, that the first value exceeds a first threshold; and
generating, via the processor, a first report corresponding to the first crew member and indicating that at least one task assigned to the first crew member should be re-assigned to another crew member.

2. The computer-implemented method of claim 1, further comprising:
analyzing, via the processor, the plurality of tasks to determine a second value that indicates a total number of times any deadline associated with any task assigned to the first crew member has been modified; and
generating, via the processor, a second report that indicates the second value.

3. The computer-implemented method of claim 1, further comprising:
determining, via the processor, a third value that indicates a total number of times any previous deadline associated with any previous task assigned to the first crew member has been modified; and
computing, via the processor, the first threshold based on the third value.

4. The computer-implemented method of claim 1, further comprising:
determining, via the processor, that the first task is complete; and
updating, via the processor, a first media asset entry corresponding to the first media asset to indicate that the first media asset can be included in the cinematic feature.

5. The computer-implemented method of claim 4, further comprising:
analyzing, via the processor, the master project schedule to determine that the first crew member has completed the first task;
determining, via the processor, a first amount of screen time associated with the first media asset; and
generating, via the processor, at least a portion of the cinematic feature based on the first amount of screen time.

6. The computer-implemented method of claim 1, further comprising:
analyzing, via the processor, the master project schedule to determine a first subset of tasks included in the plurality of tasks that have been completed by the first crew member;
analyzing, via the processor, the first subset of tasks to identify a first subset of media assets corresponding to the first subset of tasks;
computing, via the processor, a first amount of screen time associated with the first subset of tasks, wherein the first amount of screen time indicates a proportion of the cinematic feature that includes any media asset generated by the first crew member; and
generating a credits sequence based on the first amount of screen time

7. The computer-implemented method of claim 6, wherein the credits sequence indicates a type of contribution made by the first crew member to production of the cinematic feature.

8. The computer-implemented method of claim 6, further comprising assigning a first rank to the first crew member relative to other crew members based on the first amount of screen time, wherein the first crew member is specified within the credit sequence at a position according to the first rank.

9. The computer-implemented method of claim 1, further comprising generating a first portion of the cinematic feature based on a number of tasks included in the plurality of tasks completed by the first crew member.

10. The computer-implemented method of claim 9, wherein the first portion of the cinematic feature indicates that the first crew member assisted in creating the cinematic feature.

11. A non-transitory computer-readable medium storing program instructions that, when executed by a processor, cause the processor to automatically determine inefficiencies when producing cinematic features by performing the steps of:
generating, via a processor, a master project schedule associated with a cinematic feature, wherein the master project schedule includes a plurality of tasks associated with generating media assets to be included in the cinematic feature;
generating, via the processor, a first task included in the plurality of tasks, wherein the first task indicates that a first crew member is assigned to generate a first media asset by or before a first deadline;
analyzing, via the processor, the first task to determine a first value that indicates a number of times the first deadline has been modified;
determining, via the processor, that the first value exceeds a first threshold; and
generating, via the processor, a first report corresponding to the first crew member and indicating that at least one task assigned to the first crew member should be re-assigned to another crew member.

12. The non-transitory computer-readable medium of claim 11, further comprising the steps of:
analyzing, via the processor, the plurality of tasks to determine a second value that indicates a total number of times any deadline associated with any task assigned to the first crew member has been modified; and
generating, via the processor, a second report that indicates the second value.

13. The non-transitory computer-readable medium of claim 11, further comprising the steps of:
determining, via the processor, a third value that indicates a total number of times any previous deadline associated with any previous task assigned to the first crew member has been modified; and
computing, via the processor, the first threshold based on the third value.

14. The non-transitory computer-readable medium of claim 11, further comprising the steps of:
determining, via the processor, that the first task is complete; and
updating, via the processor, a first media asset entry corresponding to the first media asset to indicate that the first media asset can be included in the cinematic feature.

15. The non-transitory computer-readable medium of claim 14, further comprising:
analyzing, via the processor, the master project schedule to determine that the first crew member has completed the first task;
determining, via the processor, a first amount of screen time associated with the first media asset; and
generating, via the processor, at least a portion of the cinematic feature based on the first amount of screen time.

16. The non-transitory computer-readable medium of claim 11, further comprising the steps of:
analyzing, via the processor, the master project schedule to determine a first subset of tasks included in the plurality of tasks that have been completed by the first crew member;
analyzing, via the processor, the first subset of tasks to identify a first subset of media assets corresponding to the first subset of tasks;
computing, via the processor, a first amount of screen time associated with the first subset of tasks, wherein the first amount of screen time indicates a proportion of the cinematic feature that includes any media asset generated by the first crew member; and
generating a credits sequence based on the first amount of screen time

17. The non-transitory computer-readable medium of claim 16, wherein the credits sequence indicates a scope of contribution made by the first crew member to creation of the cinematic feature.

18. The non-transitory computer-readable medium of claim 16, further comprising generating an indication of the first crew member within the credit sequence at a position that is derived from the first amount of screen time.

19. The non-transitory computer-readable medium of claim 11, further comprising the step of generating a first portion of the cinematic feature based on a number of tasks included in the plurality of tasks completed by the first crew member, wherein the first portion of the cinematic feature indicates that the first crew member assisted in creating the cinematic feature.

20. A system, comprising:
a memory storing an analytics application; and
a processor that, when executing the analytics application, is configured to perform the steps of:
generating, via a processor, a master project schedule associated with a cinematic feature, wherein the master project schedule includes a plurality of tasks associated with generating media assets to be included in the cinematic feature,
generating, via the processor, a first task included in the plurality of tasks, wherein the first task indicates that a first crew member is assigned to generate a first media asset by or before a first deadline,
analyzing, via the processor, the first task to determine a first value that indicates a number of times the first deadline has been modified,
determining, via the processor, that the first value exceeds a first threshold, and
generating, via the processor, a first report corresponding to the first crew member and indicating that at least one task assigned to the first crew member should be re-assigned to another crew member.
